(19) United States
(12) Patent Application Publication
(10) Pub. No.: US 2025/0232082 A1
(43) Pub. Date: Jul. 17, 2025

(54) COMPUTER-IMPLEMENTED METHOD AND SYSTEM FOR DETERMINING AT LEAST ONE MACHINE

(71) Applicant: ARBURG GMBH + CO KG, Loßburg (DE)

(72) Inventor: Werner FAULHABER, Loßburg Wittendorf (DE)

(21) Appl. No.: 18/845,107

(22) PCT Filed: Mar. 8, 2023
(86) PCT No.: PCT/EP2023/055848

§ 371 Date: Sep. 9, 2024

(30) Foreign Application Priority Data
Mar. 8, 2022 (DE) 10 2022 105 432.2

(51) Int. Cl. G06F 30/20; G05B 19/418; G06F 113/10

(52) U.S. Cl. CPC G06F 30/20; G05B 19/41885; G06F 2113/10

(57) ABSTRACT

The invention relates to a computer-implemented method and system for determining at least one machine for processing plastics on the basis of criteria determined for producing a component (2.14). In a reference database (RD), reference machine data (2.4) are provided, comprising reference partial datasets (RTDS) required for determining machine parameters. User data (2.3) are provided as determined criteria in a data store (2.2), which user data (2.3) comprise data required for producing at least one component (2.14). A simulation for producing the component (2.14) takes place on the basis of the user data (2.3) on a machine by generating simulation datasets. The simulation datasets are segmented in order to extract partial datasets, wherein the partial datasets relate to machine-related machine parameters with which a machine should be operated in order to produce the component (2.14). The partial datasets are compared with reference partial datasets to identify partial matches, in order to output a minimum requirement of a machine when producing the component (2.14). The minimum requirement is compared, using federated learning, with available machines in order to determine at least one machine suitable for producing the at least one component (2.14), and this machine is then operated accordingly. As a result, at least one machine can be provided to a user for use thereof, which machine is the best-suited for this purpose, according to the circumstances.

### TECHNICAL FIELD

The disclosure relates to a method or a system for determining at least one machine for processing plastics and other plasticisable materials on the basis of criteria determined and/or determinable for manufacturing components and to an associated machine control for carrying out the method as well as to a computer program product for carrying out the method.

Before the prior art and the disclosure based on it are discussed in more detail below, the terms used in this disclosure are first defined.

When the term “component” is used in the context of this application, this is not intended to be restrictive, as the process can also be used in multi-component injection moulding, multi-cavity injection moulding, injection moulding with so-called family moulds or known special processes or also in additive manufacturing. In all these cases, components, objects and items are produced for which the term “component” is used synonymously.

When the term “process parameters” or “machine parameters” is used in the context of this application, it refers to the parameters required for the manufacture of components on plastics processing machines with which such machines manufacture components. As a rule, these parameters are not only, but in particular, the pressure, path of a feeding means as for example a feed screw, effective screw length, calculated stroke volume, shot weight, material throughput, injection pressure, holding pressure time, injection flow, temperature, injection speed, circumferential screw speed, screw torque, nozzle contact force, heating power, heating zones, filling volume, discharge volume, mass volume, drop size, drop volume, opening and closing force of a mould clamping unit, mould installation height, spacing of the mould carriers, clear column spacing, dimensions of the mould clamping surface, weight of the movable mould carrier, ejector force, ejector stroke, dry running time, machine performance, energy consumption, design and the like.

When the term “machine unit” is used in the context of this application, it refers to parts and components of a machine for processing plastics and other plasticisable materials. These machine units can be manufactured in modular form as independent assemblies and delivered to a machine. In the example of a plastic injection moulding machine, machine units can be, for example, a plasticising cylinder, a feed screw shaft, drive units, a mould clamping unit or an injection moulding unit or the like. Similar machine units are basically interchangeable and can therefore also be optimised in relation to other machine units with regard to the component to be manufactured.

When the term “reference database” is used in this application, it refers to a database in which referenced data relating to machines or machine units is already contained and/or taught in and/or entered. In particular, this reference machine data forms a reference to existing machines or machines yet to be manufactured and their machine parameters. This can be reference data within an existing machine park at a user or reference machine data from machines that are made available on the market by contract manufacturers, for example. However, reference machine data also includes data that enables the machine manufacturer to produce a new machine.

“Reference part data sets” created from the reference data in the reference database allow certain data sets to be assigned to machine parameters and process parameters, e.g. to enable certain speeds or pressures in the example of an injection moulding machine when injecting into a mould cavity or to specify the construction space conditions or the discharge conditions in a machine for the additive manufacturing of components.

Reference data may also be classified and distinguishable by class according to at least one of the following criteria, which include in particular
Classes of machine properties,
Classes of material properties,
Component classes,
Mould classes for injection moulds,
Filling time classes in the injection process for manufacturing the component,
Flow path-wall thickness ratios in the component,
Plastic classes,
Material classes.

When the term “user data” is used in the context of this application, it refers to data that allows a user to provide the process or system with sufficient information to enable the configuration of a suitable machine to be worked out. This data includes, in particular, information about the component to be manufactured, for example in the form of CAD data, preferably three-dimensional, or about a mould or cavity of such a component. Depending on the information available, the user data also includes information about the material to be processed or the corresponding material class, information about the machine or target machine data or about the process, such as target process data. User data can also include user preferences.

The term “user preference” is used in the context of this application when the user can enter information relating, for example, to the manufacturing time, the energy requirement per component, the costs per component or the like. These preferences should preferably be fulfilled, but can also be weighted or deferred by the user if required. In contrast, this is not the case, for example, with information about the component and/or a cavity.

When the term “expert knowledge” is used in this application, it refers to the knowledge that is available to an experienced operator of such a machine. This can be present or liquid knowledge, but expert knowledge also includes non-liquid knowledge that is accessible, for example, from specialised literature. In particular, this knowledge is also based on knowledge of the sequences and interrelationships of the components involved in the processes running on these machines and their interaction with each other. This expert knowledge also includes, for example, knowledge about the respective machines and their machine data or their structure as well as knowledge about materials and their properties. Expert knowledge enables a trained user to put such a machine into operation at least to the extent that a component can be manufactured and the machine is operational. However, expert knowledge also includes everything that is required to produce high-quality components.

### BACKGROUND

In many industries, there is a recognisable trend towards offering users computer-aided searches configured exactly according to their criteria and needs. With such tools, users can specify their selection criteria and then receive a (prioritised) hit list from the tool. In principle, there is a similar need for machines that process plastics or other plasticisable materials, namely to find (a) suitable system(s) for an individual “processing scenario” or to make the selection options transpar-ent, for which, however, some technical boundary conditions must be taken into account.

The following solutions are known in the state of the art:

DE 10 2005 047 543 A1 discloses a method and a device for simulating the control behaviour and/or machine behaviour of machine tools or production machines, whereby data about the machine tools or production machines is transmitted from the latter to a simulation device by means of an intranet and/or the Internet. In the method, parameter data and/or configuration data and/or hardware data and/or program data and/or performance data are transmitted as data. The simulation device stores data from several machine tools or production machines, wherein simulation results from at least two machine tools or production machines are automatically compared with each other. The simulation device further processes simulation results in such a way that after the simulation of at least two machines, a machine tool or production machine is suggested for utilisa-tion.

DE 10 2018 111 603 A1 discloses a method for configuring a robot-supported machining system in which a machining system is configured based on a task-related machining plan with several aspects of machining. For this purpose, the machining plan is transmitted to a network-based configurator and broken down into several aspects. A required configuration module is selected for each aspect of the processing plan and the operating system required for the module is loaded from a cloud and saved in the respective configuration module. The configuration plan created in this way is transferred to the processing system. All configuration modules in the operating system are linked ready for operation in a central control and the configured processing system is put into operation.

EP 1 804 997 B1 makes known an intelligent moulding system that uses data directly associated with a mould environment or a particular mould. The accessible data, which is typically stored locally in a memory device in the mould or entered via an HMI, identifies parameters that are important for setting up the mould and operating the machine. Upon receipt of such data, a machine controller configures a moulding machine to an initial setting defined by the data and considered to be close to an optimal operating condition for the mould. The data for the mould setup may include information about a filling profile for a moulded object that is divided into different zones with different thicknesses and geometries. Weighting factors for the different zones compensate for the different cooling and flow properties. The memory can also be used to store historical data about the operation of the mould, settings and alarms. The transfer of process parameters from a test bench to a machine is described, wherein the suitability of the machine is not estimated or evaluated.

US 2001/0051858 A1 describes a method for setting parameters in an injection moulding machine using data from a filling simulation to create a database with a relationship between the machine-side parameters and the product quality of the injection moulded part. The created database can then be used in a neural network.

A method for determining and displaying process parameter values of an injection moulding process in an injection mould is known from EP 3 291 959 A1. In this method, geometric data for the injection mould and/or a moulded part to be manufactured in the injection mould are determined. An injection moulding process is then carried out with the injection mould and measured values are recorded as a function of an injection time and/or an actuator position. Furthermore, a flow front position within the injection mould or the moulded part and optionally a flow front speed are determined as process parameter values based on the measured values and the geometry data as a function of the injection time and/or the actuator position. Optionally, further process parameter values can be determined as a function of the injection time and/or the actuator position and/or the flow front position. At least some of the determined process parameter values are dis-played on a display device as a function of the injection time and/or the actuator position and/or the flow front position. The information obtained in this way is not used any further.

WO 2014/183863 A1 describes a method for operating an injection moulding machine for processing plastics with a mould closing unit for opening and closing an injection mould with at least one mould cavity for producing an injection moulding, with an injection moulding unit for plasticising and injecting the plasticisable material into the mould cavity and with a control for operating the injection moulding machine. Expert knowledge about the operation of the injection moulding machine and any peripheral equipment present as well as about the manufacturing of injection mouldings in injection moulding technology is stored in the control in order to produce an injection moulding with interactive contact with an operator as required using injection moulding parameters. By providing information about the component or the mould cavity, the system and process parameters required for the manufacturing of the moulding can be calculated by the control, i.e. the machine adjusts itself to an optimum parameterisation with a known machine.

US 2002/0188375 A1 discloses a method in which the moulding conditions of an injection moulding machine are determined by carrying out virtual moulding using CAE (computer aided engineering). First, actual moulding is performed under preliminary moulding conditions to obtain an actual profile showing the change in load pressure actually measured during at least one injection step of the actual moulding. Subsequently, a virtual injection moulding is performed with CAE using the preliminary moulding conditions to obtain a virtual profile showing the change in load pressure simulated during at least one injection step of the virtual injection moulding. The preliminary moulding conditions are modified by CAE so that the virtual profile matches the actual profile in order to obtain intermediate moulding conditions. The intermediate moulding conditions are then optimised in order to obtain real moulding conditions for the injection moulding machine. This allows virtual data to be adapted and thus improved in the context of a real manufacturing process.

EP 1 302 823 B1 describes a method for the computer-aided planning of a plant in the raw materials industry, in particular a metallurgical plant, with the provision of plant data in a data structure and the input of user-specific data and/or specifications via a user interface by an authorised user. The plant is configured by linking user-specific data and/or specifications with plant data available in the data structure by means of models describing the plants and/or the processes used. The result is an output of a configured product in the form of a structured configuration pro-posal. The method describes a configuration of a plant on the basis of target data to be entered, but without selection on the basis of simulated tool or product data.

DE 10 2020 107 524 A1 discloses an injection moulding analysis method for generating an analysis condition of an injection moulding machine using at least one computer, wherein the at least one computer performs the following steps: selecting an injection moulding machine, wherein a predetermined correction amount for the injection moulding is assigned to each of the injection moulding machines, generating a second analysis condition for the selected injection moulding machine on the basis of a obtained first analysis condition and the predetermined correction amount of the selected injection moulding machine, and outputting the generated second analysis condition. The method thus describes the generation of a correction factor on the basis of which a selected injection moulding machine can be operated.

US 2005/0114104 A1 relates to a method and a device for analysing a fluid flow taking into account heat transfer effects and, in particular, a phase change from a molten state to a solid state. In particular, the method and apparatus can be applied to the analysis of an injection moulding process for producing a moulded polymer component from a polymer. In one embodiment, the method may be used to determine the pressure required to fill a mould cavity and pressure gradients intro-duced during filling of the cavity of an injection mould. The results of these analyses can be used to determine the number and location of gates to determine the best material for the component and to optimise the process conditions used in the moulding process.

The method described in DE 10 2013 008 245 A1 is used to operate an injection moulding machine for processing plastics, which has a mould clamping unit with at least one mould cavity, an injection moulding unit and a control for operating the injection moulding machine. Expert knowledge about the operation of the injection moulding machine and any peripheral devices present as well as about the manufacturing of injection moulded parts in injection moulding technology is stored in the control in order to produce an injection moulded part with interactive contact with an operator as required using injection moulding parameters. By providing information about the component or the mould cavity to the control in further steps, the parameters required for the manufacturing of the moulded part can be calculated by the control, so that a user-friendly machine setup for processing plastics is made available.

US 2002/0193972 A1 discloses a workshop setup/design and operation method for simulating a virtual workshop, which is a data model of an at least partially reorganised workshop. A quasi-manufacturing activity is performed by the virtual workshop to verify a manufacturing state and a physical transport state of the manufactured product. A real workshop is then built to match the verified virtual workshop. The built actual workshop is monitored remotely and a result of this mon-itoring is compared with a result of a verification during a virtual workshop verification process. In this way, the verification of the entire workshop can be carried out in such a way that workshop operations such as new set-up and modification can be carried out efficiently and quickly in a short time.

DE 103 52 815 A1 describes a simulation method for machining a workpiece using a machine tool. A computer is given an application programme which describes the machining of a workpiece by a machine tool in instruction steps. While processing the application programme, the computer determines machine-dependent control commands for the machine tool step by step using a simulation programme for controlling the machine tool. It uses an internal computer model of the machine tool and the determined machine-dependent control commands to determine expected actual states of the machine tool and thus simulates the execution of the machine-dependent control commands. The simulation programme is designed as control software. It determines the machine-dependent control commands as a function of a virtual time base that is independent of real time.

US 2017/0308057 A1 relates to a computer-implemented method for analysing parts, in particular for analysing the quality of the machining process and preferably the design process of a workpiece machined by at least one CNC machine. According to these aspects, the method may comprise providing a digital machine model of the CNC machine with real-time and non-real-time process data of the at least one CNC machine, wherein the real-time and non-real-time process data are recorded during the machining process of the CNC machine. The machining process is then simulated using the digital machine model based at least partially on the recorded real-time and non-real-time process data.

### BRIEF SUMMARY

The disclosure is to provide a user with at least one machine which is best suited for his application under the given circumstances.

The computer-implemented method is used to determine at least one machine for processing plastics and other plasticisable materials, which machine is preferably best suited for producing a component to be manufactured. This determination is conducted on the basis of criteria determined and/or determinable for manufacturing the at least one component. For this purpose, a reference database with reference machine data is provided, which comprises reference part data sets required in particular for determining machine parameters, wherein machine parameters are assigned to each reference part data record.

User data is also provided as specific and/or determinable criteria via a user interface in a data storage, which user data comprises data required for the manufacture of the at least one component, in particular CAD data. The user data also includes at least one group of data comprising at least material characteristics, target machine characteristics and/or target process data.

On the basis of the reference database and user data provided in this way, a simulation for manufacturing the at least one component on a machine is carried out by generating simulation data sets. Additionally or alternatively, a simulation data set can also be used that has already been generated during or for the manufacture of at least one component on the machine. These simulation data sets are now segmented for the extraction of partial data sets in order to thereby achieve the assignment to the machine-side parameters with which a machine is to be operated for the manufacture of the at least one component.

The partial data sets determined in this way are compared with the reference part data sets in the reference database for partial matches, in particular in order to obtain process parameters and machine parameters that make it possible to define more precisely how a suitable machine or machine unit is to be configured or set up. Based on the partial matches, this leads to the output of a minimum requirement for a machine or machine unit suitable for the manufacture of the at least one component.

Now at least two of the elements-which may also include other elements-comprising the user data, the simulation data sets, the partial data sets and the minimum requirements are collected from various machines. From this, clusters are formed, grouped according to the same or similar machine configurations, the same processes and/or the same or similar materials to be processed, and these clusters are analysed in order to operate machines with a minimum requirement adapted as a result of the results of the analysis using federated learning. Advantageously, with the help of federated learning, i.e. in the sense of “swarm intelligence” or “swarm knowledge”, even better algorithms and thus an even better and more reliable model for determining a suitable machine are obtained. The process is therefore suitable for being carried out on several machines and, in particular, for forming and analysing clusters with the same machine configurations, the same processes and/or the same materials to be processed. The increased amount of data obtained in this way can be used to further refine the results available in the results database.

Since the reference machine data or the information available in the machine park or on the market can be used to determine which machines with which configuration or which machine units are available on the market (this information forms the basis of the reference machine data), the minimum requirement can now be compared with the available machines or machine units. This comparison leads to the determination of at least one, preferably several, machines or machine units suitable for the manufacturing the at least one component, which may also be prioritised according to certain criteria. This machine or machine unit is then operated to produce the at least one component.

Advantageously, information such as that on which the simulation data in particular is based and which is already widely used today is therefore used to configure or identify a suitable machine or machine unit. These simulation results are the starting point for linking these simulation results with the design of a machine and thus finding the most suitable machine(s) or machine unit(s) for the manufacturing of at least one component or for creating a ranking of the machines available on the market or in a machine portfolio.

It is therefore advantageous to optimise the machine selection based on the component to be manufactured, its shape or the cavity on which the component is based. This ensures that the machine is selected or procured from an existing machine portfolio that is best suited to the corresponding component or, preferably, the associated injection mould. Advantageously, based on the appropriate segmentation of the input data, it is also possible for an inexperienced operator to carry out a machine selection in a simple and clear manner.

Preferably, a suitable machine or machine unit is determined either by a selection from a machine portfolio of a machine park of an operator, whereby the machines or machine units may also be available at different locations, and/or, if a suitable machine is available on the market from at least one supplier, possibly by proposing a production of the component to be manufactured for manufacturing on a suitable machine of the at least one supplier. The latter case relates in particular to the subcontracting of production to a contract manufacturer who currently has the suitable machine in operation. Advantageously, this creates simple possibilities for selecting from a selection of available machines a machine that is not only suitable, but also the most suitable machine for manufacturing the component to be manufactured in each case according to determined and/or determinable criteria.

Preferably, once a suitable machine or machine unit has been determined, a suitable machine can also be configured by the manufacturer and then manufactured. This is particularly the case if, even after weighing up and weighting the criteria accordingly, the conclusion is reached that it is not possible to manufacture the component to be manufactured on the existing machines or machines available to the respective user. In this case, the manufacture of a machine specially suited to the component is an alternative method.

Preferably, once a suitable machine or machine unit has been identified, it is also possible to determine globally or regionally where suitable machine units are located in order to then configure a machine for manufacturing the component. It is conceivable that it makes more sense to search the market for suitable machine units worldwide, especially when it comes to the rapid manufacturing of components. For a machine in Asia-which, in the example of an injection moulding machine, has a large mould clamping unit and a large plasticising unit-a smaller plasticising unit for the component now to be manufactured can only be supplied by the manufacturer with a corresponding delivery time. However, it may be possible to find a suitable plasticising unit on the global market in North America that can be delivered to Asia at short notice so that the machine can be quickly converted there and the component can be manufactured.

Preferably, the user data can also include user preferences that can be set linearly or discretely on the basis of a defined parameter set using a control unit. This allows a change in the minimum requirement to be analysed and output on the basis of the user preferences. Advantageously, the user can weight the machine-side or process-side user data, but can also introduce additional user preferences that relate in particular to “soft” factors such as the costs per component, the speed per component or the energy costs per component or similar. This information is advantageously incorporated into the selection of a suitable machine. As a result, components can be manufactured on a machine faster and with lower energy costs.

When segmenting the simulation data sets, the available user data is only partially used. In order to use the other user data, preferably additionally or separately, to determine the suitable machine, it can be segmented again additionally or separately to extract partial data sets. These partial data sets are also assigned to machine parameters in order to optimise the selection of a suitable machine. By segmenting the user data in addition to or separately from the extraction of partial data sets, additional information can be obtained that influences the machine parameters, which in turn determine the selection of the suitable machine.

Preferably, the method is applied to an injection moulding machine or a machine for the additive manufacturing of components. Advantageously, for such machines in particular, corresponding results from simulations are available to such an extent that such results can be accessed without further costs, which represent the starting point for determining the suitable machine.

Preferably, a filling simulation for filling a mould cavity of an injection mould/mould unit or a simulation of a component structure in additive manufacturing and/or a flow simulation of a plasticising process of the plasticisable material in a plasticising unit is used as a simulation for manufacturing the at least one component. Such simulations are already widely used in the engineering of moulding tools and in additive manufacturing for the design of injection moulds and moulding tools. They can be used to transfer a specific “manufacturing scenario” or “injection moulding scenario” into a suitable mold unit or injection mould. These simulation results are therefore the starting point for combining simulation results on the (injection moulding) tool side or component side with the design of the plasticising screw and machine, for example. All this with the aim of finding the most suitable machine or machine unit for the manufacturing of the respective component.

Machine selection can therefore be optimised based on the (injection moulding) tool or component to be manufactured. For each injection mould or component, it is possible, for example, to find the ideal or most suitable machine on the market or in a defined machine park based on its process-related properties, or to determine a suitable contract manufacturer based on its machine park. The simulation results of mould making are advantageously transferred to the selection process of a suitable injection moulding machine.

Preferably, a self-learning system is assigned to the reference database so that information for suitable machines or machine units in conjunction with associated user data from the reference database is made available for future analyses and evaluations.

Preferably, the results of the evaluation of federated learning can be used at least partially with each other, preferably cloud-based, to determine comparative results. The operator of such sys-tems can roll out an algorithm generated in this way from his “model factory” to other production sites and obtain the same good machine selection options everywhere while at the same time protecting know how.

Preferably, the algorithms generated in this way can also be made available to the machine manufacturer, at least in part, so that the models provided by the manufacturer and the expert knowledge can be further honed using this type of information.

The disclosure provides also a computer-implemented system for determining at least one machine for processing plastics and other plasticisable materials, which determines at least one suitable machine on the basis of criteria which are determined and/or determinable for the manufacturing of at least one component. For this purpose, the system has a reference database with reference machine data which can be assigned to reference part data sets for determining machine parameters; a user interface configured for providing the above-mentioned user data in a data storage; a simulation unit configured for simulating the manufacture of the at least one component on a machine on the basis of the user data by generating simulation data sets and/or a read-in unit configured for reading in simulation data sets already present on or generated for a machine; a segmentation unit configured for segmenting the simulation data sets for extracting partial data sets to the extent explained above; a first pattern matching unit configured for comparing the partial data sets with the reference data sets for partial matches; an analysis unit configured for determining a minimum requirement for a machine or machine unit in the manufacture of at least one component on the basis of the partial matches and for outputting it to an output unit; a second pattern matching unit configured for analysing at least two of the elements comprising the user data, the simulation data sets, the partial data sets (TDS) and the minimum requirements (MA)—but possibly also other elements—from different user data sets, the simulation data sets, the partial data sets (TDS) and the minimum requirements (MA), but possibly also other elements—from different machines and to form clusters therefrom, grouped according to the same or similar machine configurations, the same processes and/or the same or similar materials to be processed, and to evaluate these clusters in order to operate machines with a minimum requirement (MA) adapted as a result of the results of the evaluation by federated learning; wherein the second pattern matching unit configured for matching the minimum requirement with the available machines or machine units determined from the reference machine data to determine at least one suitable machine or machine unit. The system also comprises a suitable machine or machine unit on which the at least one component is to be manufactured in accordance with the minimum requirement.

Advantageously, the system thus allows an inexperienced user to be provided with a user- and machine-oriented and, if necessary, optimised selection of suitable machines or machine units based on the component and/or its shape or a cavity in which the component is to be manufac-A suitable machine may advantageously be available in the company's own machine park or from a contract manufacturer on the market, or it may preferably be the case that a suitable machine or machine unit is to be configured or manufactured by the manufacturer. This creates the prerequisites for selecting a machine with its technical environment and technical requirements that is equipped in such a way that the component to be manufactured can be produced in the best possible way or at least as well as possible on the suitable machine.

Preferably, a global or regional search system is provided which, after determining a suitable machine or machine unit, is configured for determining globally or regionally, e.g. within a predetermined radius, where suitable machines or machine units are located in order to configure a machine for manufacturing the at least one component. This can advantageously allow a machine to be configured more quickly if it is possible to determine globally or regionally where suitable machine units can be procured in the world in order to then, if necessary on site, convert a not yet fully suitable machine or configure a suitable machine.

Preferably, user preferences can be entered via a user interface. These user preferences can be determined linearly or discretely via a control unit on the basis of a defined set of parameters. In other words, it is possible to weight the user preferences and thus both the user data and soft factors, which, for example, enable faster and energy-optimised manufacturing of the component. The user preferences are then incorporated into the minimum requirements for the suitable machine.

Preferably, the segmentation unit is configured for segmenting not only the simulation data sets and the associated user data, but also the user data additionally or separately for the extraction of partial data sets. Advantageously, this allows additional information to be obtained that influences the machine parameters that determine the selection of a suitable machine. This applies in particular to user preferences. By segmenting the user data, additional information can be obtained in addition to or separately from the extraction of partial data sets, which influences the machine parameters, which in turn determine the selection of the suitable machine.

Preferably, the system is intended for use on an injection moulding machine or a machine for the additive manufacturing of components. For these machines in particular, appropriate tools are available in a proven form that can provide simulation data sets. These simulation data sets can be advantageously translated into real machine parameters using the boundary conditions on which the user data is based.

Preferably, suitable and proven simulations are a filling simulation for the filling of a mould cavity of an (injection) mould or of a mould unit or a simulation of a component structure in additive manufacturing and/or a flow simulation of a plasticising process of the plasticisable material in a plasticising unit. There are reliable solutions for this, which are also a good starting point for achieving a good selection result.

Preferably, a self-learning system is assigned to the reference database, which is advantageously suited to segmenting and grouping results that have already been determined in order to make them accessible for future applications.

The disclosure provides also a machine control for a machine for processing plastics and other plasticisable materials, which is configured for carrying out the method.

The disclosure provides likewise a corresponding computer program product with a program code which is stored on a computer-readable medium and is suitable for carrying out the method.

Further advantages result from the further dependent claim and the following description of an exemplary embodiment.

### BRIEF DESCRIPTION OF THE FIGURES

The disclosure is explained in more detail below with reference to an exemplary embodiment rep-resented in the attached figures, in which:

FIG. 1 shows a schematic representation of a machine using the example of an injection moulding machine,

FIG. 2 shows a schematic representation of a system for determining at least one machine,

FIG. 3 shows a schematic flow chart of the process,

FIG. 4 shows a diagram of a process extension.

### DETAILED DESCRIPTION

Before describing the disclosure in detail, it should be pointed out that it is not restricted to the respective structutal parts of the device and the respective method steps, since these structural parts and methods may vary. The terms used here are merely intended to describe particular embodiments and are not used restrictively. Moreover, when the singular or the indefinite article is used in the description or in the claim, this also refers to a plurality of these elements, unless the overall context unambiguously indicates otherwise.

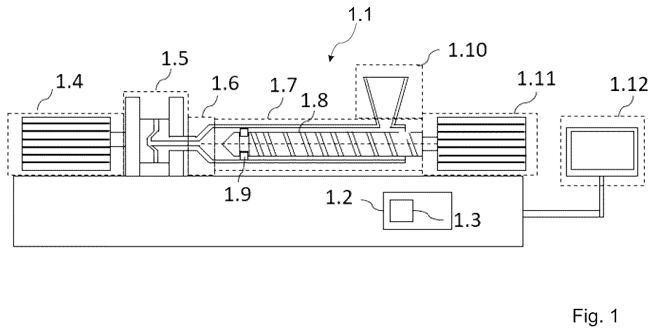

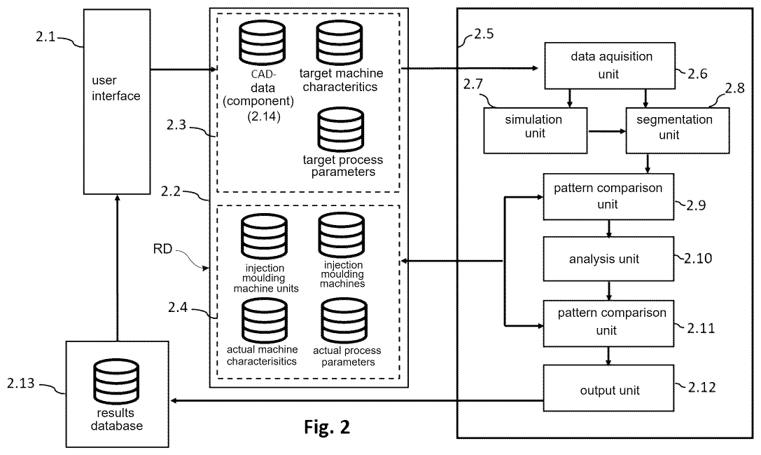

FIG. 2 shows a computer-implemented system for carrying out a computer-implemented method for determining at least one machine 1.1 for processing plastics and other plasticisable materials on the basis of criteria determined and/or determinable for manufacturing components. The machine is preferably an injection moulding machine for processing plastics and other plasticisable materials, as shown in FIG. 1, or a machine for additive manufacturing of components. In principle, it can also be used on other plastics processing machines.

The term “plasticisable materials” is to be understood broadly and includes in particular, but not only, in addition to the plastics mentioned, e.g. ceramic, metallic and/or powdery masses as well as paper, cellulose, starch, cork, etc. and also mixed materials between such plasticisable materials or recycled materials. In principle, the method can also be applied to previously plasticised materials or plastic masses that harden automatically or with the use of auxiliary agents after application.

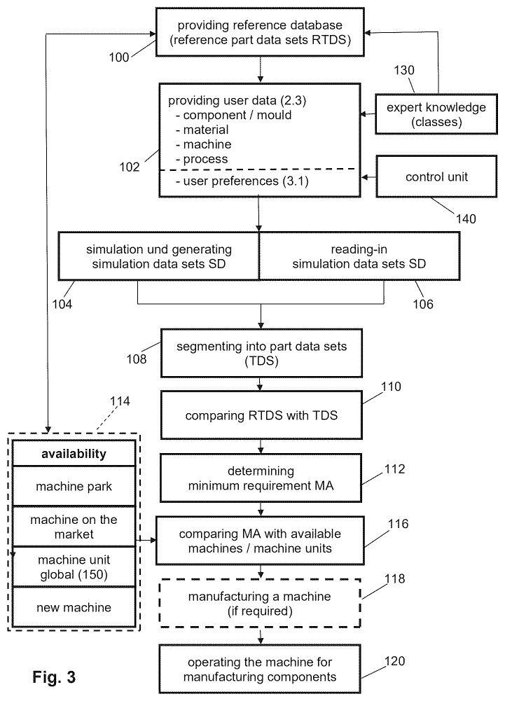

FIG. 2 shows the system for determining at least one machine 1.1 in the manner of a configurator 2.5 and the method for determining a preferably component- and user-optimised configuration of a machine or machine units of a machine, in the exemplary embodiment a plastic injection moulding machine according to FIG. 1. The specific process sequence is shown in the flow chart of FIG. 3.

The system is explained below in the exemplary embodiment using an injection moulding machine for processing plasticisable materials as shown in FIG. 1. In principle, however, the system and the method can also be used on a machine for additive manufacturing of components 2.14 as well as on machines in the plastics processing industry.

Via a user interface 2.1, user data 2.3, such as target machine characteristics of the injection moulding machine, CAD data of the component 2.14 to be manufactured and target process parameters according to FIG. 2 are initially stored in a data storage 2.2. Expert knowledge 130 and/or already existing results, e.g. from earlier process sequences of the present method, from a results database 2.13 can also be entered into the data storage 2.2.

The configurator 2.5 then uses the recorded user data 2.3 and reference machine data 2.4 to generate the results database 2.13 with component-specific and user-specific configurations of machine units of machines or machines 1.1, in the exemplary embodiment injection moulding machines, the configurations preferably being sorted in the results database 2.13 according to a requirements profile or minimum requirements MA.

In the exemplary embodiment of a cyclical injection moulding process of an injection moulding machine from a configuration of machine units (these machine units are the components of the machine in the exemplary embodiment with the reference signs 1.2 to 1.12), plasticisable material is fed into a temperature-controlled plasticising unit 1.7 via a material feed unit 1.10 into a temperature-controlled plasticising unit 1.7, plasticised by a screw shaft 1.8 with a non-return valve 1.9 and then injected into at least one cavity of the mould unit 1.5, in this case an injection mould, via the material outlet unit 1.6. Furthermore, at least one machine control 1.2 with a data storage 1.3 is provided in the machine 1.1, wherein the machine control 1.2 is operatable by a display device 1.12.

To manufacture injection moulded components (component 2.14), e.g. in a cyclical injection moulding process, a component-specific injection moulding machine is required, i.e. a machine 1.1 that meets the requirements for the manufacture of the component 2.14 and is suitable for this manufacture, so that a component with properties that meet the quality requirements can be manufactured.

For example, the number of cavities and the geometry of the cavities of the mould unit 1.5 must be adapted to the drive units 1.4, 1.11 (e.g. required clamping force, required injection force), to the plasticising unit 1.7 (e.g. screw geometry) and to the material feed unit 1.10 or to the material outlet unit 1.6. The configurator 2.5 automatically provides a component- and user-optimised configuration of a machine 1.1 via a user interface 2.1, e.g. from CAD data of the component 2.14 to be manufactured and other user data 2.3.

For this purpose, CAE simulations of the component-specific injection moulding process are carried out in a simulation unit 2.7 and the result data of the simulation (simulation data SD) are used to select suitable configurations. In principle, the simulation unit can be provided on any suitable computer, but it can also run on a machine control 1.2.

The injection moulding process respectively the manufacturing process in general can be mod-elled using a CAE simulation in the simulation unit 2.7. Such a CAE simulation usually consists of a flow simulation of the plasticised material in the mould of the mould unit 1.5 (filling simulation) and/or a flow simulation of the plasticising process (melting simulation) in the plasticising unit 1.7.

In the field of additive manufacturing, a simulation of a component structure usually takes the place of a filling simulation. For this purpose, the CAD data of the component to be manufactured and/or other user data 2.3 such as process data, e.g. material parameters, are used in the CAE simulation in order to generate component- and machine-specific target curves for the process parameters, e.g. injection pressure, holding pressure, speed of the drive units, filling volume, etc. (see above).

This enables a simulation unit 2.7 in a configurator 2.5 to perform a component-specific and user-specific CAE simulation from user data 2.3 in a data storage. This requires technical information such as data relating to the shape of the component 2.14 or cavity and also at least one group of the following data, comprising material characteristics of the material to be processed, target machine characteristics or target process data, since this information significantly determines the requirements to be fulfilled by the machine 1.1.

To determine a component- and user-optimised machine 1.1 or machine unit, the user data 2.3, comprising e.g. CAD data of the component 2.14 to be manufactured, target machine characteristics and target process data, are first entered via a user interface 2.1 and stored in a data storage 2.2, as shown in FIG. 2. A data acquisition unit 2.6 transfers the user data 2.3 to the configurator 2.5 and transfers the user data 2.3 required for the CAE simulation to the simulation unit 2.7, which then forwards the simulation data SD to the segmentation unit 2.8.

The remaining user data 2.3, in particular those, but not only those, which are not processed in the simulation unit 2.7, can be fed directly into the segmentation unit 2.8 and divided into partial data sets TDS together with the simulation data SD.

These partial data sets are then used to generate a working data set for a configuration of a machine 1.1 or machine unit which best fulfils the requirements for high-quality manufacturing of the at least one component 2.14 (as far as possible), which can be identified and determined on the basis of the simulation and the user data.

For this purpose, the work data set is compared with the reference machine data 2.4 in a first pattern comparison unit 2.9, wherein at least one criterion from the machine characteristics data or from the target process parameters or from the material characteristics data is used for comparison. As a result, comparison data is created in the pattern comparison unit 2.9.

From the comparison data, a requirement profile is created in an analysis unit 2.10 or a profiling unit as a minimum requirement MA for the machine 1.1 or machine unit to be configured, which is compared in a second comparison unit 2.11 with the stored machines 1.1 and machine units from the reference machine data 2.4. At least one component- and user-optimised machine 1.1, preferably several machines, or at least one component- and user-specific configuration of machine units that best fulfils the minimum requirement MA is selected in the second pattern com-parisonä unit 2.11.

For this purpose, the second pattern matching unit 2.11, but possibly also another system unit, is preferably configured for collecting data from at least two of the elements—but possibly also from other elements-comprising the user data 2.3, the simulation data sets SD, the partial data sets TDS and the minimum requirements MA from different machines and to form clusters grouped according to the same or similar machine configurations, the same processes and/or the same or similar materials to be processed and to evaluate these clusters in order to operate machines with a minimum requirement MA adapted as a result of the results of the evaluation by means of federated learning.

The selected machines are then sorted in an output unit 2.12 according to at least one criterion from the user data 2.3, transferred to a results database 2.13 and made available via the user interface 2.1.

In principle, a code, e.g. DataMatrix code, can be provided for the result obtained in addition to the database entry, with which the result can be called up again at any time (with all se-lected/simulated data).

It is also conceivable that a digital twin of the machine is generated in the results database 2.13, on which the simulation of this specific process for the manufacturing of the component 2.14 can then be run.

FIG. 3 shows a flow chart for a computer-implemented method for determining at least one machine suitable for the manufacturing of at least one component for processing plastics and other plasticisable materials on the basis of criteria determined and/or determinable for a manufacturing of components. In a reference database RD, reference machine data are provided in step 100, which comprise reference part data sets RTDS required for determining machine parameters. Each reference part data set is assigned machine parameters such as wall thickness, cross-sections, specific pressures or delivery rates, which can thus be assigned to a performance ca-pacity of machine units. Similarly, a specific filling quantity, a mass volume or a desired cycle time can be assigned to an injection moulding unit or the size and force of a mould clamping unit, to stay with the example of an injection moulding machine.

In step 102, user data 2.3 is provided via a user interface 2.1. The user data are determined criteria and/or criteria that can be determined by a user, which comprise data required for the manufacture of at least one component as user data 2.3. This data is preferably CAD data of the component or of a mould or cavity. In addition to this required data, the user data comprises at least one group of the following data, namely material characteristics of the material to be processed, target machine characteristics or target process data. This data can also be provided grouped by class. Expert knowledge 130 can be included in the user data 2.3 as well as in the reference machine data.

Based on the user data 2.3, a simulation for manufacturing the at least one component 2.14 on a machine 1.1 is now performed, generating simulation data sets SD in step 104 and/or, alternatively, existing simulation data sets SD that were generated during the manufacture of at least one component 2.14 on or for a machine 1.1 can be read in (step 106). In the first case, it de-pends on the user data entered whether the simulation is already carried out on a machine that is basically known or whether it is independent of the machine. Preferably, for example, a filling simulation or a simulation of a component structure in the case of additive manufacturing can also be carried out without knowledge of the properties of a machine and nevertheless allow machine parameters to be determined. In principle, the simulation can take place on the machine itself, but the configuration usually runs as an app on a PC or a comparable device, alternatively on Edge or as a cloud application.

The simulation data sets SD obtained in this way are segmented in step 108 to extract partial data sets TDS, wherein the partial data sets relate to machine-side machine parameters with which a machine 1.1 is to be operated to manufacture the at least one component 2.1.

This means that reference part data sets RTDS are available, which enable the assignment of data to machine parameters and process parameters, as well as corresponding partial data sets TDS. In step 110, the partial data sets TDS are compared with the reference partial data sets RTDS from the reference database RD for partial matches.

Based on these partial matches, a minimum requirement MA for a machine 1.1 or machine unit is now determined and output in step 112, i.e. the requirement that must at least be fulfilled by the machine in order to achieve the best possible and preferably high-quality result in the manufacture of the at least one component.

At this point, data from at least two of the elements, comprising at least the user data, the simulation data sets SD, the partial data sets TDS and the minimum requirements MA, are collected from various machines and clusters are formed therefrom, grouped according to the same or similar machine configurations, the same processes and/or the same or similar materials to be processed. These clusters are analysed in order to use federated learning to operate machines with a minimum requirement MA that has been adjusted based on the results of the analysis.

Once the minimum requirement MA has been determined in step 112, it can now be compared with corresponding data from machines or machine units that are available via available machines 1.1 or machine units. The determination required for this is carried out on the one hand using the reference machine data 2.4, which is available in the reference database RD. However, this reference data can also include all information relating to the availability in step 114.

In principle, availability relates to all available machines or machine units, be it, for example, in an operator's machine park, be it machines that are basically available on the market, such as machines at contract manufacturers, or also globally or regionally available machine units or machines that may have to be determined via a global or regional search system.

However, the available machines can also include machines that do not yet exist, but are configured on the basis of the minimum requirement MA and can therefore be manufactured. The comparison of the minimum requirement MA with the machines or machine units thus leads to the suitable machines or machine units in the result of step 116. These machines or machine units are preferably output via an output unit and made available to the results database 2.13 and can be prioritised as required according to determined and/or determinable criteria.

If the machine does not yet exist, i.e. it still needs to be manufactured, this can be done in step 118 if required.

The comparison of the minimum requirement MA with the available machines leads in step 120 to at least one machine or machine unit being operated to produce the at least one component 2.14. To make it clear once again, after determining a suitable machine 1.1 or machine unit, either a suitable machine or a suitable machine unit can be selected from an operator's machine park to configure a suitable machine and/or, if a suitable machine is available on the market from at least one supplier (contract manufacturer), a manufacturing of the component 2.14 to be manufactured can be proposed for manufacturing on the suitable machine of the at least one supplier. This allows to access machines that are not directly available in the company's own machine park. Advantageously, this may allow an important order to be processed for which no suitable machine would otherwise be available.

After determining a suitable machine 1.1 or machine unit, a global or regional search system 150 can be used to determine globally or regionally, e.g. also with a radius search, where suitable machines or machine units are located in order to configure a machine 1.1 for manufacturing the at least one component 2.14. In principle, this makes it possible, for example, to find a suitable mould closing unit at one location and a suitable plasticising unit at another location on earth. It is also possible to convert a machine in such a way that a suitable machine unit can be used, which can perhaps be obtained more quickly at any location on earth than even from the manufacturer.

Preferably, the user data also comprises user preferences which can be determined linearly or discretely on the basis of a defined set of parameters by means of a control unit 140. Such user preferences may include not only the above-mentioned user data, but also soft factors, such as the cost per component, the energy requirement per component or the manufacturing time per component or comparable preferences. The user can use the control unit 140 to determine the weighting and thus the influence of these user preferences on the result. This is because the user preferences lead to a change in the minimum requirement MA, which is provided to the user via the output unit 2.12.

By parameterising user preferences, existing assignments of moulds and machine designs can be adapted, for example with regard to the user's existing environmental conditions. This allows the user to take their company-specific situation into account when selecting the machine or machine unit, for example on the basis of machine concept templates.

When segmenting the simulation data sets SD, user data 2.3 can also be segmented in addition to or separately from the extraction of partial data sets TDS. This means that user data alone can also be used to define machine-independent criteria that can be used to advantage when selecting machines or machine units.

In principle, simulations are used that are already tried and tested and well established on the market. As a rule, the simulation for manufacturing at least one component 2.14 is a filling simulation for filling a mould cavity of an (injection) mould or a mould unit 1.5 or a simulation of a component structure in additive manufacturing and/or a flow simulation of a plasticising process of the plasticisable material in a plasticising unit 1.7. In the case of additive manufacturing, a simulation of the structure of the part to be manufactured is conceivable.

In principle, simulation results, in particular of mould construction, are thus integrated or transferred into the selection process of a suitable machine 1.1. In order to identify a suitable machine for an injection mould or a mould unit 1.5, the filling behaviour of the mould when using a specific material to be processed or a specific material class should preferably be of importance or be included in the user data 2.3.

Mould makers use so-called filling simulations during the development of the injection mould. These filling simulations make it possible to simulate the filling behaviour of the mould for each geometry. The result of this simulation can be used to calculate a data set that can be used to design the machine parameters and process parameters required to determine a suitable machine or machine unit.

Preferably, additional information on the geometry of the mould or component 2.14 as well as further information on mould-dependent process parameters is advantageous. Theoretically, it is possible to simulate the entire machine or system. It is conceivable, for example, to run a digital twin on the basis of the simulation data. In principle, however, it is sufficient to fall back on the simulations mentioned (filling simulation, melting simulation, construction simulation), as these simulation data sets SD are usually already available.

These simulation data sets SD are analysed and preferably segmented into at least the partial data sets required for the plasticising-side design of the machine 1.1. In addition, information on the mould closing side can also be segmented and/or derived. Both order-side and process-side requirements are taken into account.

In order to determine the machine parameters and process parameters, the underlying boundary conditions of the simulation must be translated into real machine parameters based on the simulation data sets SD. A direct assignment between machine and component is only possible in ex-ceptional cases. Usually, minimum limits are used, for example in the case of an injection moulding machine for the filling pressure.

In principle, it would be possible to specify a degree of coverage with the requirements for each machine and/or make suggestions for customisation based on expert knowledge. This could be done, for example, by taking user preferences 3.1 into account. It is also conceivable to specify concrete suggestions for machine parameters in order to operate the machine below a limit load in order to avoid breakdowns or to allow short-term work at the limits of the machine load.

Since simulation data sets SD are generally as good as the data on which they are based, it is also possible to provide an estimation unit that is configured for providing a sharpness statement for the machine parameters based on the quality of the simulation data. This results in a measure of successful sampling, whereby the data is preferably grouped appropriately for the sharpness statement and a quality level is determined for each group.

A self-learning system is preferably assigned to the reference database RD so that results from the process or from the results database 2.13 can in turn be fed to the reference database. The reference database is able to segment and group this reference data as required using an associated computing unit in order to use it as a basis for future evaluations. Preferably, the simulation data sets SD and the partial data sets are fed into an input layer of an AI device or data pipe-line with AI device for this purpose.

Ideally, data from similar or identical process sequences for machines running similar or identical processes with materials of the same or similar material class should be “collected” in larger injection moulding companies. This “on edge” collation and evaluation of all data makes it possible to obtain even better algorithms as part of federated learning and thus an even better and more reliable model for determining a suitable machine. The plant operator can roll out an algorithm generated in this way from its “model factory” to other production sites and obtain equally good selection options worldwide while at the same time protecting know how.

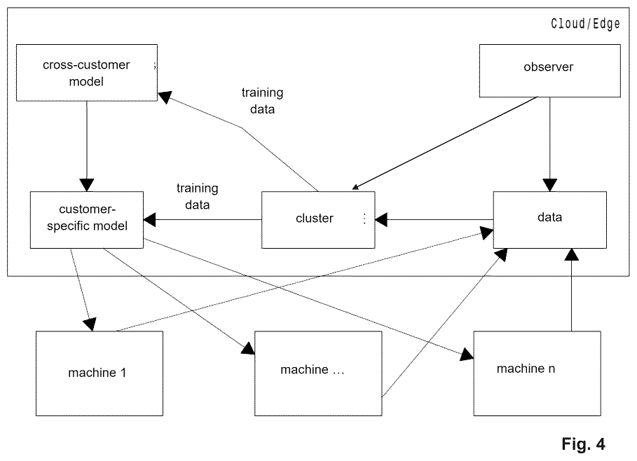

This is explained in more detail in the diagram in FIG. 4. The upper part of the figure shows a cloud/edge solution. According to FIG. 4, in particular two of the elements comprising the following data are analysed:
User data (2.3),
Simulation data sets (SD),
Partial data sets (TDS)
Minimum requirements (MA).

This data is collected from machine 1, machine . . . to machine n and clustered by an observer, e.g. according to the same or similar machine configurations, the same processes and/or the same or similar materials to be processed. These clusters are analysed and form training data for a customer-specific model, in particular for determining and selecting at least one suitable machine 1.1 in order to also operate other machines, e.g. in the customer's machine park, with the results of the analysis using federated learning or “swarm knowledge”. In particular, the model can output selection options in advance, e.g. in order to recommend, with knowledge of the machine configuration, a suitable machine to a user.

The machine manufacturer is also interested in the machine operator providing at least extracts of the algorithms generated “on edge” in the machine manufacturer's cloud. The latter collects the extracts of the algorithms from as many machine operators (customers) as possible, i.e. the content released by customers, compares them and thus sharpens the generation of a cross-customer model (deep learning).

The advantages cited with regard to the method also apply to a machine control 1.2 for a machine 1.1 for processing plastics and other plasticisable materials, provided that the machine control unit 1.2 is configured, designed and/or constructed to carry out the method accordingly.

Similarly, the advantages according to the method arise when using a computer program product with a program code that is stored on a computer-readable medium, so that the method can be carried out using the program code.

1. Computer-implemented method for determining at least one machine for processing plastics and other plasticisable materials based on criteria, which are at least one of determined and/or determinable, for a manufacturing at least one component, the method comprising the steps:
(a) Providing a reference database with reference machine data, comprises-ing reference part data sets (RTDS) required for determining machine parameters, wherein machine parameters are assigned to each reference part data set,
(b) Providing user data via a user interface as criteria, which are at least one of determined and/or determinable, in a data storage, which user data comprise data required for the manufacture of at least one component, and further comprise at least one group of the following data:
Material characteristics of a material to be processed,
Target machine characteristics,
Target process data,
(c) Performing a simulation for manufacturing the at least one component on a machine while generating simulation data sets or reading in simulation data sets generated during the manufacture of at least one component on the machine or generating the simulation data sets and reading in the simulation data sets, based on the user data,
(d) Segmenting the simulation data sets for extracting partial data sets, wherein the partial data sets relate to machine-side machine parameters with which a machine is to be operated for manufacturing the at least one component,
(e) Comparing the partial data sets (TDS) with the reference part data sets (RTDS) from the reference database for partial matches,
(f) Outputting a minimum requirement to a machine or machine unit when manufacturing the at least one component based on the basis of the partial matches,
(g) wherein at least two of the elements comprising the user data, the simulation data sets, the partial data sets (TDS) and the minimum requirements are collected from different machines and clusters are formed therefrom, grouped according to at least one of the same or similar machine configurations, the same processes and/or the same or similar materials to be processed, and these clusters are evaluated for obtaining evaluation results in order to operate machines with a minimum requirement adapted as a result of the evaluation results of the evaluation by means of federated learning,
(h) Determining available machines or available machine units from the reference machine data,
(i) Comparing the minimum requirement with the available machines or available machine units to determine at least one machine or machine unit as a suitable machine or a suitable machine unit for manufacturing the at least one component,
(j) Operating the machine or machine unit for manufacturing the at least one component.

2. Method according to claim 1, wherein, after determining the suitable machine or machine unit according to step (i), either a suitable machine or suitable machine unit for setting up a suitable machine is selected from at least one of a machine park of an owner-operator and/or, if a suitable machine is available on the market, from at least one supplier, a manufacturing of the component to be manufactured is proposed for manufacturing on the suitable machine of the at least one supplier.

3. Method according to claim 1, wherein, after determining the suitable machine or machine unit according to step (i), a suitable machine is configured by the manufacturer in accordance with the minimum requirement (MA).

4. Method according to claim 1, wherein, after determining the suitable machine or machine unit according to step (i), it is determined globally or regionally where suitable machine units are located in order to configure a machine for manufacturing the at least one component.

5. Method according to claim 1, wherein the user data comprise user preferences determinable linearly or discretely based on a defined parameter set by a control unit, and in wherein a change in the minimum requirement is analysed and output based on the user preferences.

6. Method according to claim 1, wherein during the segmenting of the simulation data sets, the user data are also segmented additionally or separately for extraction of partial data sets.

7. Method according to claim 1, wherein the method is applied to an injection moulding machine or to a machine for additive manufacturing of components.

8. Method according to claim 1, wherein the simulation for manufacturing the at least one component is at least one of a filling simulation for filling a mould cavity of an injection mould or a simulation of a component structure in additive manufacturing or a flow simulation of a plasticising process of the plasticisable material in a plasticising unit.

9. Method according to claim 1, wherein a self-learning system is assigned to the reference database, reference machine data being supplied to the reference database, which are segmented and grouped.

10. Method according to claim 1, comprising the steps:
Comparing the evaluation results at least partially with each other, and determining comparison results,
Sharpening the reference machine data required for the manufacturing based on the comparison results.

11. Computer-implemented system for determining at least one machine for processing plastics and other plasticisable materials based on criteria, which are at least one of determined or determinable, for manufacturing at least one component, the system comprising:
a reference database with reference machine data, comprising reference part data sets required for determining machine parameters, wherein machine parameters are assigned to each reference part data set,
a user interface configured for providing user data as criteria, which are at least one of determined or determinable, in a data storage, the user data comprising data required for the manufacturing of the at least one component, and furthermore comprising at least one group of the following data:
Material characteristics of a material to be processed,
Target machine characteristics,
Target process data,
a simulation unit configured for simulating the manufacture of the at least one component on a machine based on the user data, while generating simulation data sets, or a read-in unit configured for reading in simulation data sets, the simulation data sets being generated on the machine based on the user data during the manufacture of at least one component, or the simulation unit and the read-in unit for providing the simulation data sets,
a segmentation unit configured for segmenting the simulation data sets for extracting partial data sets, wherein the partial data sets relate to machine-side machine parameters with which a machine for manufacturing the at least one component is to be operated,
a first pattern matching unit configured for comparing the partial data sets with the reference partial data sets from the reference database for partial matches,
an analysis unit configured for determining a minimum requirement for a machine or machine unit in manufacturing the at least one component based on the partial matches and for outputting it the minimum requirement to an output unit,
a second pattern matching unit configured for collecting data from at least two of the elements comprising the user data, the simulation data sets, the partial data sets and the minimum requirements from different machines and for forming clusters therefrom, grouped according to at least one of the groups comprising identical or similar machine configurations, identical processes, or identical or similar materials to be processed, and for evaluating these clusters for obtaining evaluation results in order to operate machines with a minimum requirement adapted as a result of the evaluation results by federated learning,
wherein the second pattern matching unit is configured for comparing the minimum requirement with the available machines or machine units determined from the reference machine data to determine at least one machine or machine unit suitable for manufacturing the at least one component,
a suitable machine or machine unit configured for manufacturing the at least one component in accordance with the minimum requirement.

12. System according to claim 11, wherein a configurator is configured for at least one of configuring or manufacturing the suitable machine or machine unit at a manufacturer after determining a suitable machine or machine unit.

13. System according to claim 11, wherein a global or regional search system is provided which, after determining the suitable machine or machine unit, is configured for determining globally or regionally where suitable machine units are located in order to configure the machine for manufacturing the at least one component.

14. System according to claim 11, wherein the user interface is configured for entering user preferences to be determined linearly or discretely based on the basis of a defined parameter set by a control unit, and wherein the analysis unit is configured for changing the minimum requirement based on the user preferences.

15. System according to claim 11, wherein the segmentation unit is configured for segmenting the user data in addition or separately to the simulation data sets for extracting partial data sets (TDS).

16. System according to claim 11, wherein the system is provided on an injection moulding machine or on a machine for the additive manufacturing of components.

17. System according to claim 11, wherein the simulation for producing the at least one component is at least one of a filling simulation for filling a mould cavity of an injection mould or a simulation of a component structure in additive manufacturing, or a flow simulation of a plasticising process of the plasticisable material in a plasticising unit.

18. System according to claim 12, wherein the reference database is assigned a self-learning system configured for segmenting and grouping the reference machine data.

19. Machine control for a machine for processing plastics and other plasticisable materials, wherein the machine control is configured for carrying out the method according to claim 1.

20. A computer program product comprising a program code stored on a computer readable medium for carrying out the method according to claim 1.
